(19) United States
(12) Patent Application Publication
(10) Pub. No.: US 2004/0252079 A1
(43) Pub. Date: Dec. 16, 2004

(54) Integrated flat panel display

(76) Inventors: Joe Sheu, Hsin-Chu (TW); Pc Huang, Hsin-Chn (TW); Bingo Teng, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,109

(22) Filed: Sep. 3, 2003

(30) Foreign Application Priority Data
Jun. 13, 2003 (TW) 92210834

(51) Int. Cl. G09G 3/20

(52) U.S. Cl. 345/55

(57) ABSTRACT

An integrated flat panel display having a memory card reader integrated therein for facilitating access of data in a memory card is proposed. A multimedia processing device is further integrated into the flat panel display so that a user can directly read data in a memory card without a computer, and can directly play data of formats like audio/video, picture, text and game. The integrated flat panel display can greatly increase the convenience in use of information. Moreover, the application range of the flat panel display can also be much enhanced.

### FIELD OF THE INVENTION

The present invention relates to an integrated flat panel display and, more particularly, to a flat panel display integrating a memory card reader.

### BACKGROUND OF THE INVENTION

In today's digital information age, people can't do without various kinds of information products in everyday life. Small memory cards are widely used storage media in many information products like digital cameras, walkmans, and personal digital assistants (PDAs). These small memory cards are used for storage of various digital data, and are especially used for storage of data of audio/video format such as pictures, movies, mp3 files. Therefore, the use of memory cards are inevitable in the digital information age.

In common use, it is necessary to use a card reader connected to a computer to display data in a memory card when one wants to browse or watch movies, music or pictures stored in the memory card. Because a card reader is generally not built in existent computers, the user needs to provide a card reader himself and then connect the card reader to a computer for reading the content of a memory card. Regardless of the format of data stored in a memory card, a card reader can only perform or play data in the memory card through a computer. Therefore, except directly browsing data stored in a memory card on an information product like a digital camera, a user needs to prepare a card reader and a computer to browse or watch data stored in the memory card, hence resulting in much inconvenience in use.

Nowadays, memory cards are usually used for storage of files like pictures, movies and mp3 music. Users are much desirous of a computer peripheral integrating a card reader. It is preferred that the integrated computer peripheral can directly execute or play files of common audio/video formats in a memory card without using a computer, thereby greatly enhancing convenience in use.

### SUMMARY AND OBJECTS OF THE PRESENT INVENTION

The primary object of the present invention is to provide a flat panel display integrating a memory card reader to enhance convenience in use of memory cards.

Another object of the present invention is to provide a flat panel display integrating a memory card reader and a multimedia processing device so that the flat panel display can directly play files of common formats in a memory card.

To achieve the above objects, the present invention integrates a memory card reader into a flat panel display to let a user conveniently access data in a memory card. The memory card reader is an integrated card reader, and can read current memory cards of various standards. The card reader has a bi-directional interface, which can be connected to a computer for transmission of files. The flat panel display has a signal input terminal for receiving signals inputted to the flat panel display. The present invention further integrates a multimedia processing device into the flat panel display integrating a card reader so that the flat panel display can directly play files of common formats in a memory card by using the inbuilt card reader and multimedia processing device without connection to a computer. Through the integrated device, the use of information is more convenient. Moreover, the application range and added value of the integrated flat panel display can be much enhanced.

The various objects and advantages of the present invention will be more readily understood from the following detailed description when read in conjunction with the appended drawings, in which:

### BRIEF DESCRIPTION OF DRAWING

FIG. 1 is a diagram of an integrated flat panel display of the present invention; and

FIG. 2 is a diagram of a multimedia processing device of the present invention.

### DETAILED DESCRIPTION OF PREFERRED EMBODIMENT

Small memory cards have become storage media of various digital electronic products in the market. The format of files stored in small memory cards are mainly movies, pictures, music and texts. It is necessary to use a card reader connected to a computer to display and play the content of a memory card when one wants to browse or use files in the memory card. Because the use of memory card is more popular, it is very inconvenient for a user to read the content of a memory card through a card reader each time.

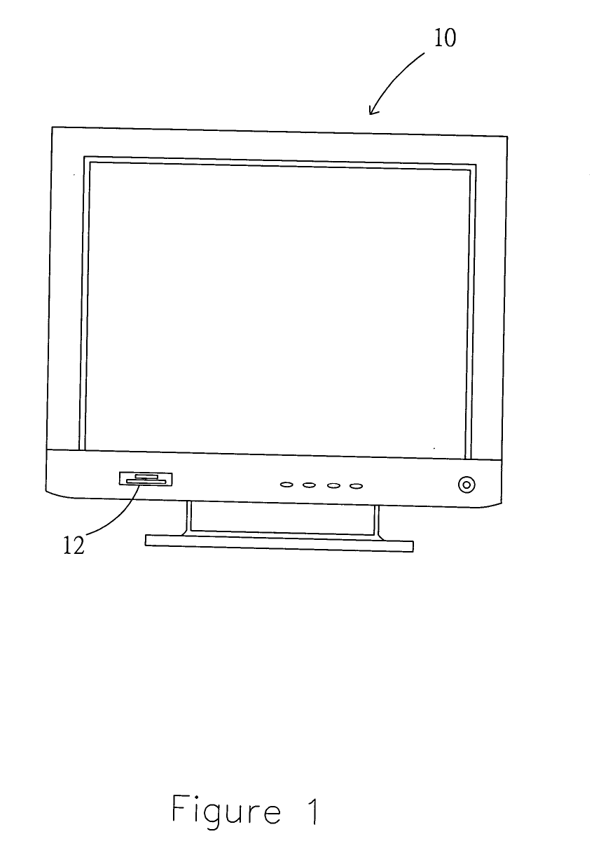

In order to let users more convenient access the content of a memory card, the present invention integrates a card reader 12 on an outer frame of a flat panel display 10 (shown in FIG. 1) because each user will certainly make use of a display to monitor the operation situation of a computer when he uses the computer. The flat panel display 10 can be a liquid crystal display (LCD), a plasma display panel (PDP), an organic light-emitting diode (OLED), or a field emission display (FED), each being light-weighted and thin and occupying less occupied. The card reader 12 is integrated into an outer frame of the flat panel display 10. The card reader 12 has a bi-directional interface, usually being a universal serial bus (USB), which is used for connection with a computer for file transmission. Integrating the card reader 12 on the flat panel display 10 will let a user more conveniently use the card reader 12 to read the content of a memory card because the display is usually in front of the user. Moreover, the manufacturing cost of the flat panel display 10 integrating the card reader 12 is less than that of the card reader 12 and the flat panel display 10 separately manufactured. Besides, the added value of the flat panel display 10 integrating the card reader 12 is much enhanced.

The above flat panel display receives signals from a computer via a signal input terminal disposed thereon. The signal input terminal is usually a 15-pin D-sub connector or a digital visual interface (DVI) connector, or has both the above two common connectors of display.

Because there are many kinds of memory cards in the market such as compact flash (CF) cards, memory stick (MS) cards, multimedia cards (MMC), smart media (SM) cards, secured digital (SD) cards and XD-picture cards, the above card reader integrated into a display is preferred to be an integrated card reader capable of reading two or more types of the above memory cards. Users thus need not to worry about the types of memory cards. The integrated card reader can even support microdrives of type II CF interface to diversify usable storage media and apply to various situations.

In order to let users more conveniently use computer multimedia and save the space occupied by computer peripherals, the present invention further integrates common devices (e.g., USB hub, speaker, microphone, camera, keyboard, mouse and hand-writing input device) on the above integrated flat panel display.

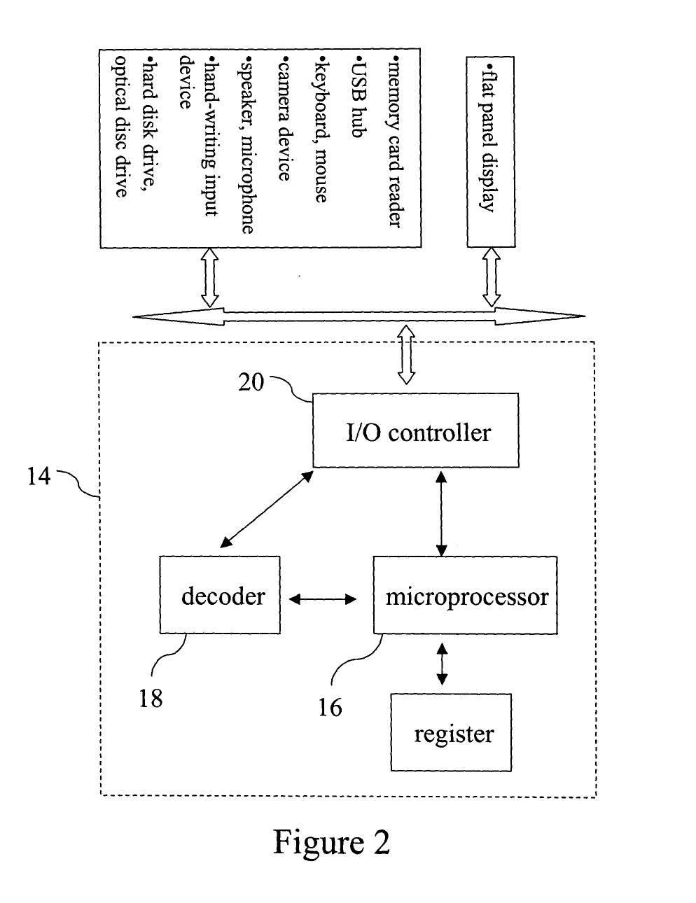

Nowadays, memory cards are generally used for storage of data of format like audio/video, picture, and music. The present invention further builds a multimedia processing device 14 in the above flat panel display integrating a card reader. The multimedia processing device are coupled with the flat panel display and the card reader. As shown in FIG. 2, the multimedia processing device 14 comprises a microprocessor 16, a decoder 18 and an I/O controller 20. The microprocessor 16 is used to execute, operate and control received data. The decoder 18 is coupled with the microprocessor 16, and is used to receive and decode media data. The I/O controller 20 controls input and output of data. Many interface control devices of IDE, memory card, and USB are built in the controller. Through the multimedia processing device 14 having the microprocessor 16 and the decoder 18, a user can directly read media data in a memory card without turning on a computer or even external connection to a computer. After the multimedia processing device 14 automatically determines the format of data stored in the memory card and then performs processing, audio/video data are outputted to the flat panel display and a speaker to let the user more conveniently use multimedia data in the memory card. Because no external connection to a computer is required, the application range of the integrated flat panel display is wider. For instance, the integrated flat panel display can apply to commodity advertisement, wherein a memory card storing advertising movies or pictures is directly inserted into the card reader of the flat panel display to directly play the content of the memory card. This is very convenient for commercial firms, and will also save the cost.

The above multimedia processing device has an inbuilt software control interface, whose control menu is displayed on the flat panel display so that a user can select the function to be executed. The multimedia processing device can handle common audio/video formats including MPEG series formats, MP3, WMA, WAV, CD music format, and JPEG picture format. The multimedia processing device can further handle specific text file formats like TXT format and specific game program format.

An IDE expansion interface can further be built in the integrated flat panel display of the present invention. The IDE expansion interface is coupled with the multimedia processing device, and is directly controlled by the multimedia processing device for access actions thereof. Users can directly connect a hard disk drive or an optical disc drive of IDE interface with the IDE expansion interface and then play or execute stored data through the multimedia processing device without connection to a computer. When an optical disc drive is connected, the multimedia processing device can be used to directly play CD, VCD, SVCD and DVD discs.

To sum up, the present invention integrates a memory card reader on an outer frame of a flat panel display to let a user conveniently access data in a memory card. The present invention further integrates a multimedia processing device into the flat panel display integrating a card reader so that the flat panel display can directly play files of common formats in a memory card by using the inbuilt card reader and multimedia processing device without connection to a computer. Through the integrated flat panel display, the use of information is more convenient, and the application range and added value thereof can be much enhanced.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An integrated flat panel display comprising:
a flat panel display having a signal input terminal, said signal input terminal being used for reception of signals inputted to said flat panel display; and
a peripheral integrated on an outer frame of said flat panel display, said peripheral at least comprising a memory card reader, said memory card reader having a bi-directional interface for data transmission.

2. The integrated flat panel display as claimed in claim 1, wherein said signal input terminal can be a 15 pin D-sub connector or a DVI connector, or has both said 15 pin D-sub connector and said DVI connector.

3. The integrated flat panel display as claimed in claim 1, wherein said flat panel display can be an LCD, a PDP, an OLED, or an FED.

4. The integrated flat panel display as claimed in claim 1, wherein said memory card reader is an integrated card reader capable of reading two or more types of memory cards, said readable types of memory cards are selected among the group composed of CF cards, MS cards, MMC cards, SM cards, SD cards and XD-picture cards.

5. The integrated flat panel display as claimed in claim 1, wherein said memory card reader can read microdrives.

6. The integrated flat panel display as claimed in claim 1, wherein said bi-directional interface is a USB.

7. The integrated flat panel display as claimed in claim 1, wherein said peripheral further comprises a USB hub.

8. The integrated flat panel display as claimed in claim 1, wherein said peripheral further comprises a set of speakers.

9. The integrated flat panel display as claimed in claim 1, wherein said peripheral further comprises a microphone.

10. The integrated flat panel display as claimed in claim 1, wherein said peripheral further comprises a camera.

11. The integrated flat panel display as claimed in claim 1, wherein said peripheral further comprises a mouse.

12. The integrated flat panel display as claimed in claim 1, wherein said peripheral further comprises a keyboard.

13. The integrated flat panel display as claimed in claim 1, wherein said peripheral further comprises a hand-writing input device.

14. An integrated flat panel display comprising:
a flat panel display;
a multimedia processing device built in said flat panel display and coupled with said flat panel display; and
a peripheral integrated on an outer frame of said flat panel display and coupled with said multimedia processing device, said peripheral at least comprising a memory card reader, said memory card reader having a bi-directional interface for data transmission.

15. The integrated flat panel display as claimed in claim 14, wherein said multimedia processing device can handle data of format like audio/video, music, picture, game program, and text.

16. The integrated flat panel display as claimed in claim 15, wherein said audio/video format can be MPEG I or MPEG II.

17. The integrated flat panel display as claimed in claim 15, wherein said music format can be MP3, CD, WAV or WMA.

18. The integrated flat panel display as claimed in claim 15, wherein said picture format can be JPEG.

19. The integrated flat panel display as claimed in claim 14, wherein said peripheral further comprises a sound output device and a sound output terminal.

20. The integrated flat panel display as claimed in claim 19, wherein said multimedia processing device can process data from said peripheral to display image signals on said flat panel display and play sound signals through said sound output device or output the sound signals via said sound output terminal.

21. The integrated flat panel display as claimed in claim 14, wherein said bi-directional interface is a USB.

22. The integrated flat panel display as claimed in claim 14, wherein said peripheral further comprises a microphone.

23. The integrated flat panel display as claimed in claim 14, wherein said peripheral further comprises a camera.

24. The integrated flat panel display as claimed in claim 14, wherein said flat panel display can be an LCD, a PDP, an OLED, or an FED.

25. The integrated flat panel display as claimed in claim 14, wherein said memory card reader is an integrated card reader capable of reading two or more types of memory cards, said readable types of memory cards are selected among the group composed of CF cards, MS cards, MMC cards, SM cards, SD cards and XD-picture cards.

26. The integrated flat panel display as claimed in claim 14, wherein said memory card reader can read microdrives.

27. The integrated flat panel display as claimed in claim 14, wherein said multimedia processing device has an inbuilt IDE expansion interface controller.

28. The integrated flat panel display as claimed in claim 27, wherein said peripheral further comprises an IDE expansion interface for direct expansion of an IDE device, and said IDE expansion interface can be directly controlled by said multimedia processing device.

29. The integrated flat panel display as claimed in claim 28, wherein said IDE device can be a hard disk drive or an optical disc drive.

30. The integrated flat panel display as claimed in claim 14, wherein said multimedia processing device has an inbuilt control software, whose control menu is displayed on said flat panel display.

31. The integrated flat panel display as claimed in claim 14, wherein said peripheral further comprises a mouse.

32. The integrated flat panel display as claimed in claim 14, wherein said peripheral further comprises a keyboard.

33. The integrated flat panel display as claimed in claim 14, wherein said peripheral further comprises a hand-writing input device.
